(19) United States
(12) Patent Application Publication
(10) Pub. No.: US 2017/0147773 A1
(43) Pub. Date: May 25, 2017

(54) SYSTEM AND METHOD FOR FACILITATING HEALTH MONITORING BASED ON A PERSONALIZED PREDICTION MODEL

(71) Applicant: KONINKLIJKE PHILIPS N.V., EINDHOVEN (NL)

(72) Inventors: Anja VAN DE STOLPE, Vught (NL); Folke Charlotte NOERTEMANN, Raeren (BE); Wilhelmus Franciscus Johannes VERHAEGH, Heusden gem. Asten (NL)

(21) Appl. No.: 15/345,587

(22) Filed: Nov. 8, 2016

Related U.S. Application Data
(60) Provisional application No. 62/257,290, filed on Nov. 19, 2015.

(51) Int. Cl. G06F 19/00

(52) U.S. Cl. CPC G06F 19/3418; G06F 19/345

(57) ABSTRACT

In certain implementations, health monitoring of an individual may be provided based on an individual-specific prediction model. In some implementations, a prediction model for health monitoring may be obtained. Health information associated with an individual may be obtained. The health information may indicate a co-occurrence of health conditions of the individual. An individual-specific prediction model associated with the individual may be generated based on the prediction model and the co-occurrence indication. Subsequent health information associated with the individual may be obtained. The subsequent health information may indicate one or more of: (i) subsequent measurements of the individual observed after the co-occurrence of the health conditions; or (ii) subsequent health conditions of the individual observed after the co-occurrence of the health conditions. A health status of the individual may be predicted based on the individual-specific prediction model and the subsequent health information.

### CROSS-REFERENCE TO PRIOR APPLICATIONS

This application claims the benefit of or priority of U.S. patent application Ser. No. 62/257,290, filed Nov. 19, 2015, all of which are incorporated herein in whole by reference.

### FIELD OF THE INVENTION

The invention relates to health monitoring (e.g., disease monitoring, wellness monitoring, weight monitoring, or other health monitoring).

### BACKGROUND OF THE INVENTION

Despite considerable medical therapy advances, heart failure continues to be a major and growing public health problem. For example, a majority of patients are readmitted within a short span of time after being released from a hospital where they were treated for heart failure. In recent years, many heart failure management programs have provided some form of patient surveillance to facilitate early exacerbation detection and timely intervention, including automated electronic transfer of physiological data and other techniques to enhance home monitoring of heart failure patients. However, typical home monitoring systems (for heart failure patients or patients suffering from other conditions) are based on prediction models that are not personalized for a patient and/or fail to compensate for fewer patient observables (e.g., as compared to observables taken at a hospital). As a result, in some cases, such home monitoring systems may often generate inaccurate predictions or false positive alerts. These and other drawbacks exist.

### SUMMARY OF THE INVENTION

Aspects of the invention relate to methods, apparatuses, and/or systems for facilitating health monitoring based on a prediction model. In one or more implementations, health monitoring of an individual may be based on an individual-specific prediction model. In one or more other implementations, a prediction model utilized for the health monitoring of an individual need not be specific to the individual (as described in further detail below).

In certain implementations, a computer system may be programmed to: obtain a prediction model for health monitoring; obtain health information associated with an individual, wherein the health information indicates a co-occurrence of health conditions of the individual; generate an individual-specific prediction model associated with the individual based on the prediction model and the co-occurrence indication; obtain subsequent health information associated with the individual, wherein the subsequent health information indicates one or more of (i) subsequent measurements of the individual observed after the co-occurrence of the health conditions or (ii) subsequent health conditions of the individual observed after the co-occurrence of the health conditions; and predict a health status of the individual based on the individual-specific prediction model and the subsequent health information.

In some implementations, the computer system may be programmed to obtain the health information, the subsequent health information, or other information from one or more health monitoring devices (e.g., remote health monitoring device, local health monitoring device, etc.). Each of the health monitoring devices may comprise one or more sensors programmed to collect health-related sensor data. As an example, the health monitoring devices may comprise insertable cardiac monitors, cardiac event recorders, Holter monitors, heart rate trackers, urine monitoring devices, temperature monitoring devices, scales, saturation measurement devices, blood monitoring devices (e.g., clinical chemistry/hematology/biomarker), skin conductance measurement devices, impedance measurement devices, or other health monitoring devices. The sensors may comprise cameras, microphones, oximetry sensors, heart rate sensors, tactile sensors, glucose sensors, accelerometers, gyroscopes, magnetometers, barometric pressure sensors, humidity sensors, temperature sensors, skin conductance sensors, global position system (GPS) sensors, proximity sensors, or other sensors.

Various other aspects, features, and advantages of the invention will be apparent through the detailed description of the invention and the drawings attached hereto. It is also to be understood that both the foregoing general description and the following detailed description are exemplary and not restrictive of the scope of the invention. As used in the specification and in the claims, the singular forms of “a”, “an”, and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 shows an example system for facilitating health monitoring, in accordance with one or more implementations.

FIG. 2 shows a representation of an example prediction model and data input variables thereof, in accordance with one or more implementations.

FIGS. 3 and 4 show representations of example prediction model and data input variables thereof in a home monitoring situation, in accordance with one or more implementations.

FIG. 5 shows a use case scenario of health monitoring based on a personalized prediction model, in accordance with one or more implementations.

FIGS. 6A-6F show a use case of an individual and observables thereof at various points in time, in accordance with one or more implementations.

FIG. 7 shows a flowchart of a method of facilitating health monitoring of an individual based on an individual-specific prediction model, in accordance with one or more implementations.

FIG. 8 shows a flowchart of a method of facilitating health monitoring of an individual and predicted health status notification via a health monitoring device, in accordance with one or more implementations.

FIG. 9 shows a flowchart of a method of facilitating health monitoring of an individual at a health monitoring device via a remote computer system, in accordance with one or more implementations.

FIG. 10 shows a flowchart of a method of generating an individual-specific prediction model for predicting a health status of an individual, in accordance with one or more implementations.

FIG. 11 shows a flowchart of a method of facilitating health monitoring of an individual without one or more measurements of an individual, in accordance with one or more implementations.

FIGS. 12-13 show flowcharts of methods of facilitating health monitoring of an individual with respect to one organ or tissue based on a predicted status of another organ or tissue, in accordance with one or more implementations.

### DETAILED DESCRIPTION OF THE INVENTION

In the following description, for the purposes of explanation, numerous specific details are set forth in order to provide a thorough understanding of the implementations of the invention. It will be appreciated, however, by those having skill in the art that the implementations of the invention may be practiced without these specific details or with an equivalent arrangement. In other instances, well-known structures and devices are shown in block diagram form in order to avoid unnecessarily obscuring the implementations of the invention.

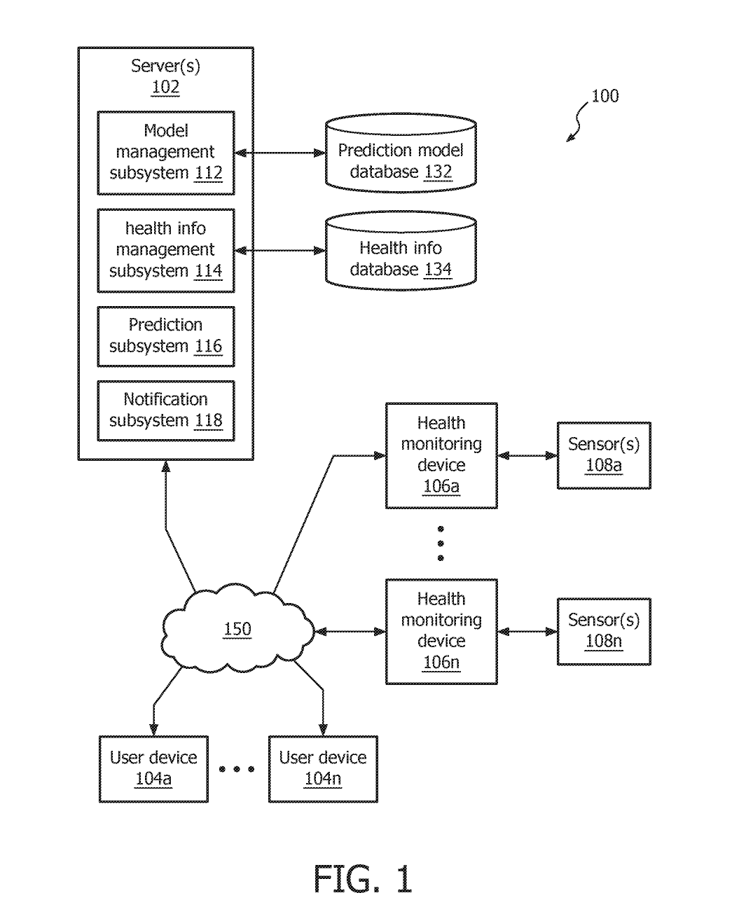

FIG. 1 shows a system 100 for facilitating health monitoring, in accordance with one or more implementations. As shown in FIG. 1, system 100 may comprise server 102 (or multiple servers 102). Server 102 may comprise model management subsystem 112, health information management subsystem 114, prediction subsystem 116, notification subsystem 118, or other components.

System 100 may further comprise user device 104 (or multiple user devices 104a-104n). User device 104 may comprise any type of mobile terminal, fixed terminal, or other device. By way of example, user device 104 may comprise a desktop computer, a notebook computer, a tablet computer, a smartphone, a wearable device, or other user device. In some implementations, user device 104 may comprise one or more health monitoring devices and/or sensors thereof (e.g., health monitoring devices 106a-106n, sensors 108a-108n, etc.) for obtaining health information of an individual. Users may, for instance, utilize one or more user devices 104 to interact with server 102 or other components of system 100. It should be noted that, while one or more operations are described herein as being performed by components of server 102, those operations may, in some implementations, be performed by components of user device 104 or other components of system 100.

In some implementations, one or more health monitoring devices 106 may be separate and independent from user devices 104 having general functionalities such as those available on common desktop computers, notebook computers, tablet computers, smartphones, etc. Health monitoring devices 106 may comprise insertable cardiac monitors, cardiac event recorders, Holter monitors, heart rate trackers, urine monitoring devices, temperature monitoring devices, scales, saturation measurement devices, blood monitoring devices (e.g., clinical chemistry/hematology/biomarker), skin conductance measurement devices, impedance measurement devices, or other health monitoring devices.

Health Monitoring Based on a Prediction Model

In some implementations, a prediction model may be personalized for an individual and used to facilitate health monitoring of the individual (e.g., a patient or other individual). As an example, health information associated with the individual may be used to generate a personalized prediction model, and the personalized prediction model may be used along with subsequent health information (e.g., obtained after the health information used to generate the personalized prediction model) to predict a health status of the individual.

In one use case, for example, one or more measurements of the individual, one or more health conditions of the individual, one or more indications of co-occurrences of the health conditions, or other health information may be used to generate the personalized prediction model. The personalized prediction model may be used along with the subsequent health information to generate (i) a prediction of the likelihood that the individual will sustain or re-sustain a morbid event (e.g., heart failure, kidney failure, liver failure, respiratory failure, transient ischemic attack, stroke, or other morbid event), (ii) a prediction of a change in status of a chronic disease of the individual (e.g., an exacerbation related to the chronic disease, an improvement related the chronic disease, the extent of the change in status, the probability of the change in status, or other change-in-status prediction), or (iii) other prediction (e.g., effect of a drug on the individual, health status related to any disease, etc.). In another use case, the prediction model may comprise a non-individual-specific Bayesian model. The individual-specific prediction model (used to generate a health status prediction) may comprise an individual-specific Bayesian model associated with the individual that is generated based on the non-individual-specific Bayesian model and health information associated with the individual. In other use cases, other types of prediction models may be utilized, including Frequentist models, parametric models, non-parametric models, data-mining-based models, statistical models, or other types of models.

In some implementations, model management subsystem 112 may obtain a prediction model. As an example, the prediction model may be obtained from a database (e.g., prediction model database 132) based on a user selection of the prediction model, a type of health status to be predicted for an individual (e.g., heart-failure-related predictions, kidney-failure-related predictions, liver-failure-related predictions, transient-ischemic-attack-related predictions, stroke-related predictions, etc.), or other criteria. As described below, model management subsystem 112 may modify the prediction model or otherwise use the prediction model to generate an individual-specific prediction model associated with an individual.

In some implementations, health information management subsystem 114 may obtain health information associated with an individual. Model management subsystem 112 may obtain a prediction model and generate an individual-specific prediction model associated with the individual based on the obtained prediction model and the health information. As an example, the obtained health information may indicate (i) one or more measurements of the individual, (ii) one or more health conditions of the individual (e.g., determined based on the measurements), (iii) one or more co-occurrences of the health conditions, or (iv) other information. Model management subsystem 112 may generate the individual-specific prediction model based on the prediction model, the measurements of the individual, the health conditions of the individual, the co-occurrences of the health conditions, or other information. Upon generation or obtainment, the individual-specific prediction model and the health information may be respectively stored (e.g., in prediction model database 132, health information database 134, or other storage if not already stored therein).

As another example, the health information may be obtained from one or more health monitoring devices (e.g., insertable cardiac monitors, cardiac event recorders, Holter monitors, heart rate trackers, urine monitoring devices, temperature monitoring devices, scales, saturation measurement devices, blood monitoring devices, skin conductance measurement devices, impedance measurement devices, or other health monitoring devices). These health monitoring devices may comprise one or more sensors, such as cameras, microphones, oximetry sensors, heart rate sensors, tactile sensors, glucose sensors, accelerometers, gyroscopes, magnetometers, barometric pressure sensors, humidity sensors, temperature sensors (e.g., body temperature sensors, skin temperature sensors, ambient temperature sensors, etc.), skin conductance sensors, global position system (GPS) sensors, proximity sensors, or other sensors. The sensors may, for instance, be configured to obtain measurements of the individual (e.g., heart-related measurements, kidney-related measurements, body temperature, pH level, urine output, glucose levels, or other measurements) or other information related to the individual (e.g., temperature of the individual's environment, humidity of the individual's environment, the individual's current location, other individuals detected near the individual via facial recognition, radio frequency identification (RFID) tag, or other techniques, or other information). In one scenario, a health monitoring device may obtain one or more measurements of the individual (e.g., based on information from one or more sensors), and provide information regarding the measurements to a computer system (e.g., comprising server 102) over a network (e.g., network 150) for processing. In another scenario, upon obtaining the measurements, the health monitor device may determine one or more health conditions of the individual based on the measurements, and provide information regarding the health conditions to the computer system over a network. In yet another scenario, the health monitoring device may automatically provide information (e.g., obtained health information, other information related to the individual, etc.) to the computer system (e.g., comprising server 102). If, for instance, the health monitoring device is offline (e.g., not connected to the Internet, not connected to the computer system, etc.), the health monitoring device may store the information and provide the information to the computer system when the health monitoring device comes online (e.g., when the online status is detected by an application of the user device).

As yet another example, the health information may be obtained via one or more manual inputs at one or more user devices (e.g., a health monitoring device that is also a user device, a tablet computer, a smartphone, or other user device). In one use case, when a patient is admitted to a hospital for an episode of heart failure or other morbid event, a physician or other hospital staff (e.g., a nurse, technician, etc.) may submit one or more patient observables for the patient during one or more periods of the patient's stay at the hospital (e.g., until the patient is released from the hospital). These patient observables may, for instance, be submitted as measurements of the patient to supplement measurements obtained via sensors of health monitoring devices or in lieu of the measurements that would otherwise be obtained via such sensors. In a further use case, after the patient is released from the hospital, the patient or other individual assisting the patient (e.g., the patient's caretaker, the patient's family member, etc.) may submit patient observables for the patient as measurements of the patient to supplement measurements obtained via sensors of health monitoring devices or in lieu of the measurements that would otherwise be obtained via such sensors. The patient observables submitted in the foregoing use cases (e.g., by the physician or other hospital staff, the patient or other individual assisting the patient, etc.) may, for example, be submitted using one or more applications at one or more user devices. In some cases, the user devices may automatically provide the submitted patient observables to a computer system (comprising server 102). As an example, if a user device is offline (e.g., not connected to the Internet, not connected to the computer system, etc.), one or more applications of the user device may store the information and provide the information to the computer system when the user device comes online (e.g., when the online status is detected by an application of the user device). In this way, for instance, a user need not wait for the user device to come online before submitting patient observables to the user device (or applications thereof), allowing the patient observables to be collected and submitted at any time (e.g., regardless of whether the user device is currently online).

In some implementations, health information management subsystem 114 may obtain subsequent health information associated with an individual. As an example, the subsequent health information may comprise additional health information corresponding to a subsequent time (after a time corresponding to health information that was used to generate an individual-specific prediction model for the individual). The subsequent health information may indicate (i) one or more subsequent measurements of the individual (e.g., measurements observed after measurements used to generate the individual-specific prediction model was observed, measurements observed after an indication of a co-occurrence of health conditions determined based on the prior-observed measurements, etc.), (ii) one or more subsequent health conditions of the individual (e.g., determined based on the subsequent measurements), (iii) subsequent co-occurrences of the health conditions, or (iv) other information. As another example, the subsequent health information may be obtained from one or more health monitoring devices, via one or more manual inputs at one or more user device, or via other approaches. The subsequent health information may be utilized to further modify an individual-specific prediction model associated with the individual (e.g., new health information may be used to dynamically modify the prediction model), utilized as input to the individual-specific prediction model to predict a health status of the individual, etc.

In some implementations, prediction subsystem 116 may predict a health status of an individual based on an individual-specific prediction model associated with the individual. As an example, the individual-specific prediction model may comprise a modified version of a non-individual-specific prediction model that was modified based on prior health information associated with the individual. The individual's subsequent health information may be obtained, and prediction model 116 may provide the subsequent health information as input to the individual-specific prediction model to generate a prediction of the individual's health status. The health status prediction may comprise a prediction of the likelihood that the individual will sustain or re-sustain a morbid event (e.g., heart failure, kidney failure, liver failure, respiratory failure, transient ischemic attack, stroke, or other morbid event), (ii) a prediction of a change in status of a chronic disease of the individual (e.g., an exacerbation related to the chronic disease, an improvement related the chronic disease, the extent of the change in status, the probability of the change in status, or other change-in-status prediction), or (iii) other prediction (e.g., effect of a drug on the individual, health status related to any disease, etc.).

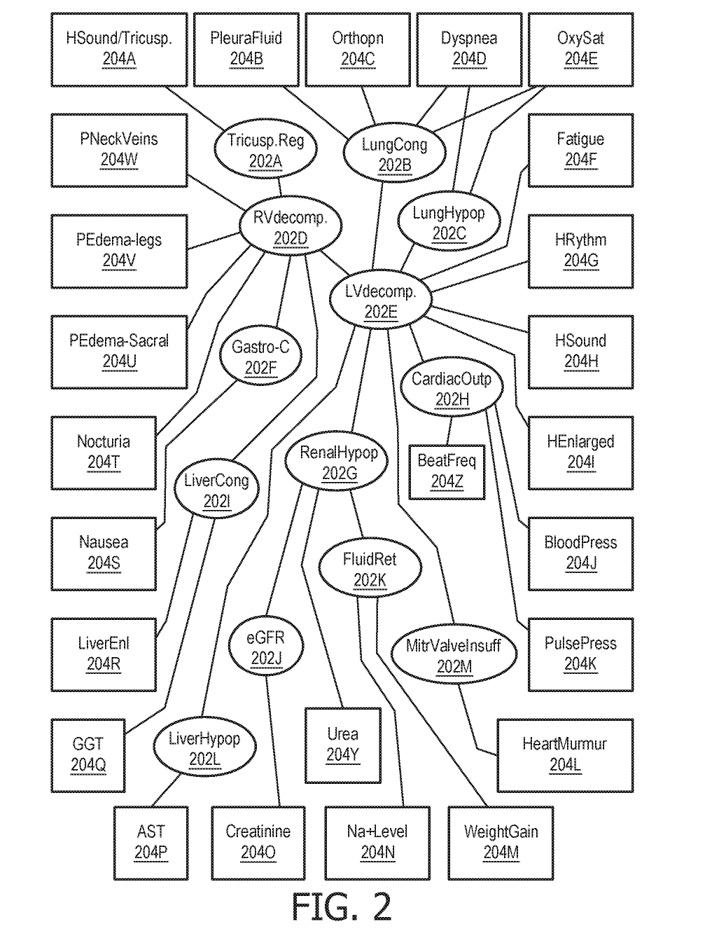

In one use case, with respect to FIG. 2, a prediction model (e.g., an individual-specific prediction model) may comprise a graph having nodes 202 (e.g., nodes corresponding to tricuspedalic regurgitation, lung congestion, lung hypoperfusion, right heart valve decompensation, left heart valve decompensation, gastrointestinal congestion, renal hypoperfusion, cardiac output, liver congestion, estimated glomerular filtration rate (eGFR), fluid retention, liver hypoperfusion, mitralic valve insufficiency, or other nodes). The prediction model and data input variables 204 may be utilized to predict a health status of an individual. Data input variables 204 may comprise observables to be provided as health information input for one or more of nodes 202 to generate their respective outputs (e.g., respective outputs of nodes 202a, 202f, and 202i may be provided as input to node 202d, respective outputs of nodes 202b, 202c, 202d, 202g, 202h, and 202l may be provided as input to node 202e, respective outputs of nodes 202d and 202e may be provided as input for predicting a health status of an individual, etc.) or other observables.

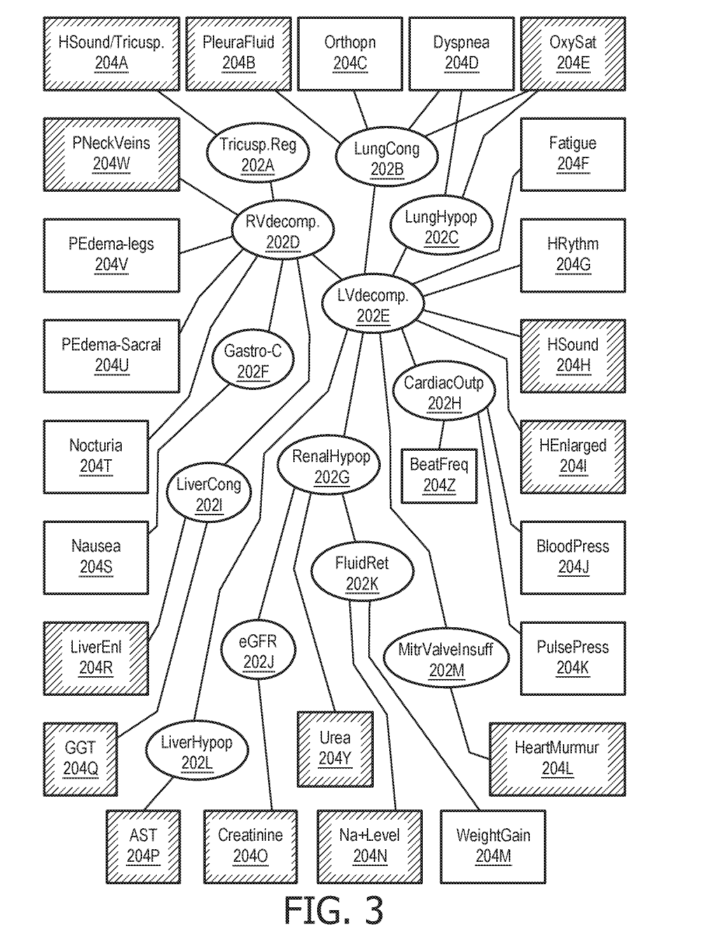

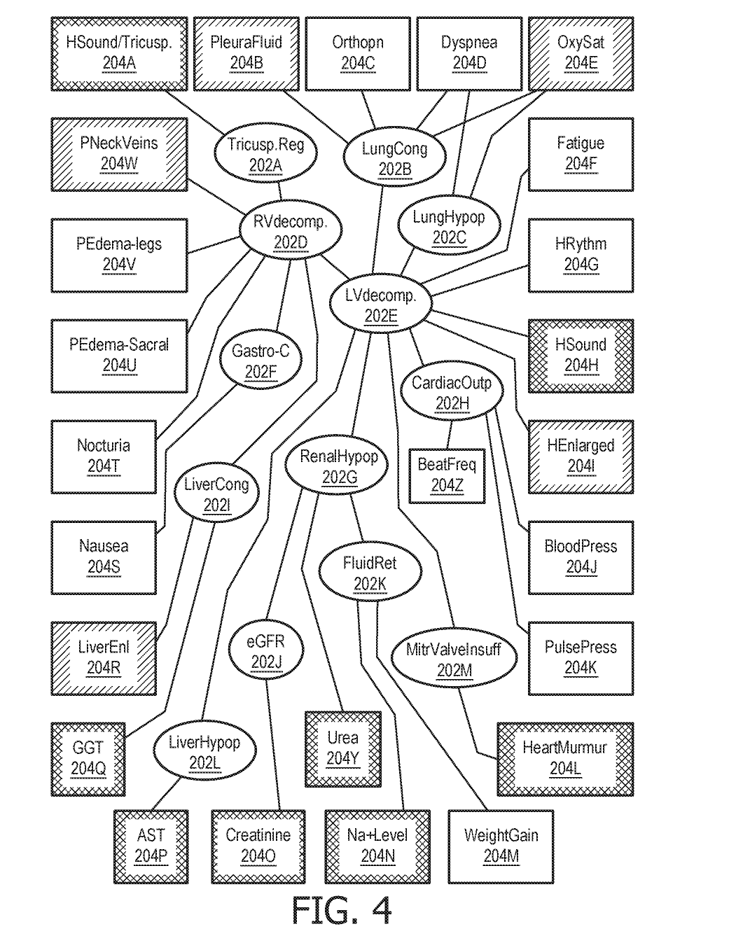

In other use cases, with respect to FIGS. 3 and 4, not all of the data input variables 204 may be available as input for predicting a health status of an individual. As an example, in a particular home situation, only orthopnea, dyspnea (e.g., which/how much activity causes shortness of breath), fatigue, heart rhythm, blood pressure, pulse pressure, weight gain, nausea, nocturia, pitting edema, and beating heart frequency, of the data input variables 204 may be available as input for predicting the individual's health status. As another example, in another home situation, Heart Sound of the Tricuspedalic valve, gamma-glutamyl transpeptidase (GGT), aspartate transaminase (AST), creatinine, urea nitrogen levels (e.g., in urine or other bodily fluids), sodium level, heart murmur, or heart sound may additionally be available as input for predicting the individual health status.

In some implementations, notification subsystem 118 may provide a notification regarding a predicted health status of an individual to one or more other components of system 100. As an example, one or more health monitoring devices having one or more sensors may obtain health information associated with the individual (e.g., measurements of the individual, health conditions of the individual, or other health information) and provide the health information to health information management subsystem 114. After the health information is processed to generate the predicted health status of the individual, notification subsystem 118 may provide a notification regarding the predicted health status to at least one of the health monitoring devices (e.g., to cause the health monitoring device to present the predicted health status via one or more output devices of the health monitoring device) via one or more wired or wireless connections. As another example, notification subsystem 118 may provide a notification regarding the predicted health status to one or more user devices, such as a desktop computer, a notebook computer, a tablet, a smartphone, a wearable device, or other user device, via one or more wired or wireless connections.

Although some implementations are described herein with respect to an individual-specific prediction model, a prediction model utilized for health monitoring of an individual need not necessarily be specific to the individual in one or more other implementations. In some implementations, a prediction model (e.g., individual-specific or non-individual-specific) for health monitoring may be obtained. As an example, the prediction model may comprise a plurality of nodes associated with organs or tissues, such as a first node associated with a first organ or tissue, a second node associated with a second organ or tissue, a third node associated with a third organ or tissue, and so on. The prediction model may be utilized to predict a status of the individual (e.g., a status of one or more of the organs or tissues of the individual, a status of the individual as a whole, etc.).

In some implementations, a status of the individual may be predicted using a multi-layer approach. As an example, a status of the first organ or tissue of the individual (e.g., a condition of the first organ or tissue) may be predicted based on health information associated with the individual, one or more parameters of the nodes of the prediction model, etc. A status of at least one of the other organs or tissues of the individuals may then be predicted based on the predicted status of the first organ or tissue. As such, for example, one or more predicted statuses of at least one of the organs or tissues of the individual may be utilized to predict one or more statuses of at least another one of the organs or tissues of the individual. With respect to FIG. 2, for example, the individual's urea nitrogen levels, creatinine levels, and sodium or potassium levels may be utilized to predict a status of individual's kidney function, and the individual's kidney function status may be utilized (e.g., alone or in combination with one or more other organ or tissue function statuses or other information) to predict a status of the individual's heart function.

In one use case, a status of the first organ or tissue of the individual may be predicted based on measurements of the function of the first organ or tissue of the individual (or other health information associated with the individual) and a parameter of the first node associated with the first organ or tissue. In another use case, the prediction of the status of the first organ or tissue may additionally or alternatively be based on measurements of the function of at least one other organ or tissue of the individual and/or a parameter of at least one other node associated with at least one other organ or tissue. Upon predicting the status of the first organ or tissue, the predicted status of the first organ or tissue may be utilized to predict the status of at least one other organ or tissue of the individual.

In another use case, the first node (of the prediction model) associated with the first organ or tissue may be modified based on health information associated with the individual. As an example, one or more parameters of the first node may be added, modified, or removed such that those parameters of the first node (or parameter values thereof) represents a current condition of the first organ or tissue associated with the first node. In a further use case, at least one other node may be modified based on the modified first node. Additionally, or alternatively, the modification of the other node may be based on health information associated with the individual. With respect to FIG. 2, for example, the individual's urea nitrogen levels, creatinine levels, and sodium or potassium levels may be utilized as input to modify node 202c so that node 202c represents the current kidney function level of the individual. Nodes 202b, 202d, and 202e, various inputs 204, and/or other information may be utilized as input to modify node 202a so that node 202a represents the current heart function of the individual. Node 202a, various inputs 204, and/or other information may be utilized to predict a heart failure status of the individual.

Generation of Individual-Specific Prediction Model

As discussed, in some implementations, an individual-specific prediction model may be generated for an individual based on a non-individual-specific prediction model and health information associated with the individual. In some implementations, model management subsystem 112 may generate a prediction model comprising a graph based on known casual disease relationships and validated quantitative parameters. As an example, the known causal disease relationships and validated quantitative parameters (e.g., literature/research/clinical expertise-derived normal and disease-associated distributions of input laboratory values) may be used to form the nodes of the graph and the respective causative edges thereof. The prediction model may then be personalized for an individual (e.g., a patient or other individual) by introducing personalized parameters derived from the individual's health information, including, for example, input variables taken of the individual when the individual is first admitted to a hospital, input variables taken of the individual during one or more time periods of the individual's stay at the hospital, input variables taken of the individual immediately prior to the individual's release from the hospital (e.g., input variables from the last set of tests for the individual during the particular stay at the hospital). It should be noted that, although some examples described herein derive “learning” data of an individual in a hospital setting, the learning data may be obtained at one or more other settings (e.g., clinical, home, or other setting) in other examples.

In some implementations, the prediction model may be modified to generate the individual-specific prediction model by modifying the prediction model to include one or more parameters based on the individual's health information indicating one or more co-occurrences of health conditions (e.g., model modification by adding the parameters, by modifying the parameters if already existing in the prediction model, etc.). Upon modification, the individual-specific prediction model may comprise modified versions of parameters of the prediction model (prior to the modification) or parameters not included in the prediction model (prior to the modification). As an example, a heart failure patient who has diabetes may have a worse baseline kidney function than a heart failure patient without such co-morbidity. As such, the prediction model for the heart failure patient with diabetes may be adjusted to account for any reduced kidney functions attributable to the patient's diabetes. In this way, for instance, when subsequent monitoring of the patient indicates reduced kidney functions, a system utilizing the personalized prediction model may not necessarily predict a heart failure exacerbation even if the patient's health situation would have otherwise generated such a prediction using a prediction model that did not account for the co-morbidity, thereby reducing inaccurate predictions, false positive alerts, or other issues.

As another example, co-occurring health conditions of the individual may comprise two or more normal population variants co-occurring in the individual. In one use case, patients of different races or ethnicities may generally have health condition spectrums that vary among the different races or ethnicities. For example, the normal spectrum of creatinine levels, sodium levels, pulse pressure, systolic blood pressure, or other observables in one group (e.g., racial, ethnic, regional, etc.) (or subgroups thereof) may be different from the normal spectrum of those foregoing observables in another group. By taking into consideration these normal population variants—whether they are indicative of disease or not, the prediction model for the individual may reduce inaccurate predictions, false positive alerts, or other issues.

In some implementations, model management subsystem 112 may update an individual-specific prediction model associated with an individual. As an example, the individual-specific prediction model may be dynamically updated as additional health information associated with the user is obtained. The most current health information (e.g., the latest observables taken of the individual) may, for instance, be used to modify the individual-specific prediction model so that the prediction model continues to reflect and account for specificities of the individual (e.g., current co-morbidities of the individual or other aspects specific to the individual).

In some implementations, model management subsystem 112 may obtain score information associated with an individual. The score information may indicate one or more scores associated with one or more sets of measurements of the individual or health conditions of the individual. As an example, a physician may assign (i) a score for a set of measurements or health conditions taken or determined for the patient when the patient is first admitted to a hospital, (ii) one or more scores for one or more sets of measurements or health conditions taken or determined for the patient during one or more respective time periods of the patient's stay at the hospital, (iii) a score for a set of measurements or health conditions taken or determined for the patient immediately prior to the patient's release from the hospital, or (iv) other scores for other sets of measurements or health conditions. Health information management subsystem 114 may obtain these assigned scores and associate the assigned scores with the patient in a database (e.g., health information database 134), and other subsystems 112 may obtain the assigned scores from the database (e.g., for generating an individual-specific prediction model, for use in providing a prediction of the patient's health status, etc.).

Upon obtaining a score associated with a set of measurements or health conditions, model management subsystem 112 may associate the obtained score with a subset of measurements or health conditions that is related to the set of measurements or health conditions. As an example, the set of measurements or health conditions may comprise a number of types of measurements or health conditions, and the related subset may comprise fewer types of measurements or health conditions than the number of types of measurements or health conditions of the set (of measurements or health conditions). With respect to FIGS. 2-4, for instance, the set of measurements or health conditions may comprise all of data input variables 204, while the related subset may comprise only some of the data input variables 204. As another example, the related subset may comprise a subset of the measurements or health conditions of the set (of measurements or health conditions) with which the score is associated. As yet another example, the related subset may comprise a subset of the same or similar measurements or health conditions as the set (of measurements or health conditions) with which the score is associated. As a further example, the related subset may comprise a set of measurement or health condition ranges that a subset of the set of measurements or health conditions fall within.

In one use case, observables of a patient may be taken when the patient is admitted to a hospital (or other setting). A physician (e.g., cardiologist, nephrologist, or other physician) may review these observables, including measurements or health conditions with respect to weight, heart rate, respiratory rate, amount of pitting edema (e.g., at the ankles or other areas), fatigue (e.g., which/how many normal daily activities the patient has trouble performing because of fatigue), nausea, dyspnea (e.g., which/how much activity causes shortness of breath), orthopnea (e.g., dyspnea when lying down), nycturia (e.g., how often does the patient wake up to urinate at night), or other observables. Upon review, the physician may assign a score (e.g., 1-10 rating or other scoring technique) to this set of observables that reflects the patient's health status at the time the set of observables was taken (e.g., a status with respect to a chronic disease, a status with respect to a morbid event, a status with respect to a particular health condition, or other status). During one or more other times, the physician may similarly review and assign a score for each set of observables of the patient (e.g., observables taken during one or more respective time periods of the patient's stay at the hospital, observables taken immediately prior to the patient's release from the hospital, etc.). Despite the scores (for the “grade” of the disease at hand) being assigned by the physician based on the physician's review of a full set of observables, the scores may be assigned to respective subsets of the observables (e.g., in the inference mode). For example, although other observables were considered in determining a score, the determined score may be assigned to a subset comprising only those observables suitable for collection in a home monitoring situation. The assignment of the scores to the respective subsets may then be used to personalize a prediction model for the patient or otherwise used to facilitate health monitoring.

In a further use case, when the observables of the patient (e.g., measurements of the patient, health conditions of the patient, etc., suitable for collection in a home monitoring situation) are subsequent taken, the subsequent observables may be compared to the respective subsets of observables to which scores have been assigned. If, for instance, the values of the subsequent observables are similar to the values of the observables in a particular subset, the score associated with the subset may be used as a score for the patient's health status score or weighted heavily in predicting the health status. On the other hand, if the values of the subsequent observables are not similar to the values of the observables in the subset, the associated score may be weighted lightly (or have no weight) in predicting the health status. In this way, for example, a score (e.g., a health status score) that was determined for an individual based on a larger set of observables (e.g., observables collected at a hospital) may still be utilized to predict a health status of the individual based on a smaller set of observables (e.g., observables collected in a home monitoring situation). As such, the prediction based on the assigned scores may reflect at least to some extent a physician's expertise and judgement when presented with a larger set of observables even though only a smaller set of observables is available. Such personalization for prediction of an individual's health status may reduce data noise and/or increase sensitivity and specificity of scoring.

In some implementations, observables of an individual that are not typically quantified may be quantified (e.g., as measurements of the individual) and utilized to facilitate health monitoring and/or health-related predictions. As an example, the quantified observables may be utilized as measurements of the individual to generate an individual-specific prediction model associated with the individual, as measurement inputs to the individual-specific prediction model to generate a prediction of the individual health status, etc. As another example, the quantified observables may enable more accurate comparisons between sets of observations of the individual at different time points.

In some scenarios, observables can be measured at a home using specific devices and provided to a prediction model (e.g., automatically provided upon establishing a connection with a system hosting the prediction model) to obtain a result from the prediction model with regard to disease or other health status of an individual. Coupling the prediction model to these devices may enable quantification of certain observables that are traditionally not quantified (e.g., heart and lung sounds) so that they may be entered into the prediction model as quantitative values, allowing quantitative comparisons between measurements at different time points. The coupling of the prediction model to such devices may additionally or alternatively enable results traditionally derived in a lab to be obtained in a home monitoring situation (e.g., coupling a Magnotech device to the prediction model to enable measurement of c-reactive protein, brain natriuretic peptide, sodium levels, urea nitrogen levels, creatinine, aspartate aminotransferase, gamma-glutamyl transferase, or other observables).

In some scenarios, one or more devices that may be used to obtain health information may comprise: (i) a device to measure weight (e.g., a scale), (ii) a device to measure c-reactive protein, brain natriuretic peptide, sodium levels, urea nitrogen levels, creatinine, aspartate aminotransferase, or gamma-glutamyl transferase (e.g., a Magnotech device), (iii) a blood pressure device, (iv) a heart rhythm measurement device, (v) an electronic stethoscope to quantitatively measure heart sounds (e.g., mitralic and tricuspedalic insufficiency, gallop, etc.), lung sounds, or other sounds, (vi) a device to quantitatively measure lung sounds, pleurafluid, or enlarged heart (e.g., a bioimpedance spectroscopy-based device), (vii) a device to quantitatively measure congested enlarged liver or prominent neck veins, (viii) a device to quantitatively measure pleurafluid, enlarged heart, cardiac output, or mitralic and tricuspedalic valve insufficiency (e.g., an ultrasound device), (ix) a device to quantitatively score pitting edema (e.g., a bioimpedance-based device), (x) a device to measure breathing rate, (xi) a device to measure oxygen saturation (e.g., an oximetry device), or (xii) other device.

In some scenarios, some observables may be provided via a questionnaire or other approach in a quantified or other form. As an example, a patient or other individual acting on behalf of the patient may quantify the patient's symptoms by providing the severity of the symptoms as direct input for a prediction model via a user device (e.g., a desktop computer, a notebook computer, a tablet, a smartphone, a wearable device, or other user device). Such symptoms may, for instance, comprise weight gain, fatigue, orthopnea, nausea, pitting edema (e.g., pretibial, bilateral, sacral when rising in the morning, etc.), or other symptoms.

In some implementations, a prediction model may comprise a graph having a plurality of nodes associated with organs or tissues (or functions thereof), and one or more parameters of the nodes may be added, modified, or removed to generate an individual-specific prediction model. In some implementations, the nodes of the prediction model may comprise one or more nodes associated with a first organ or tissue, one or more nodes associated with a second organ or tissue, one or more nodes associated with a third organ or tissue, and so on. As an example, when a first health condition (related to the first organ or tissue) of an individual is observed to have co-occurred with one or more other health conditions (e.g., a second health condition related to the second organ or tissue, a third health condition related to a third organ or tissue, etc.) of the individual, a first node related to the first organ or tissue may be selected to be modified to account for the co-occurring first health condition in predicting a health status of the individual with respect to at least one of the other co-occurring health conditions (related to the other organs or tissues). The first node (related to the first organ or tissue) may be modified based on the first health condition, a measurement of the individual (e.g., from which the first health condition is determined), or other observable (e.g., related to the first health condition) by adding, modifying, or removing a parameter of the first node.

In some use cases, with respect to FIG. 2, the prediction model may comprise a graphic having nodes 202 (e.g., node 202a corresponding to heart function, node 202b corresponding to lung function, node 202c corresponding to kidney function, node 202d corresponding to liver function, node 202e corresponding to fluid balance, or other nodes). Data input variables 204 (e.g., variables 204a-204p) may comprise observables to be provided as input for one or more of nodes 202 to generate their respective outputs (e.g., respective outputs of nodes 202b-202e may be provided as input to node 202a, outputs of node 202a may be provided as input for predicting a health status of an individual, etc.) or other observables (e.g., variables 204r-204s comprising observables to be provided as input for predicting the individual's health status).

In some use cases, with respect to FIGS. 3 and 4, not all of the data input variables 204a-204s may be available as input for predicting a health status of an individual. As an example, in a particular home situation, only weight, swollen ankles (e.g., severity of swollen ankles), temperature, dyspnea (e.g., which/how much activity causes shortness of breath), and blood pressure of the data input variables 202 may be available as input for predicting the individual's health status. As another example, in another home situation, ultrasound results, sodium or potassium levels, urea nitrogen levels (e.g., in urine or other bodily fluids), heart rate or rhythm may additionally be available as input for predicting the individual health status.

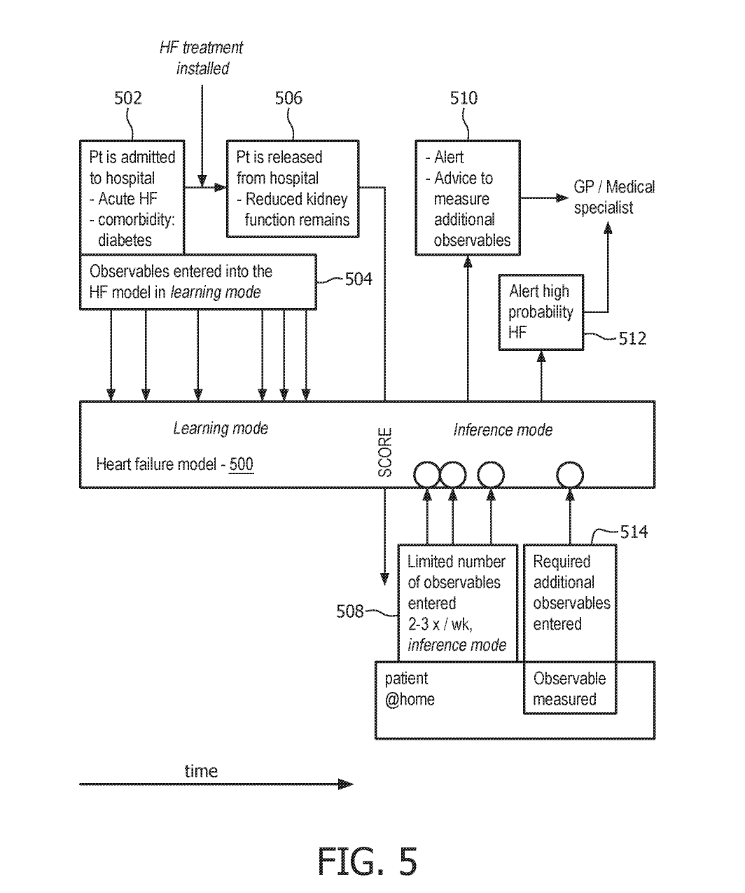

FIG. 5 shows a use case scenario of health monitoring based on a personalized prediction model 500, in accordance with one or more implementations. As an example, in one scenario, a patient may be admitted to a hospital for an episode of heart failure (502). At the hospital, the patient's observables are entered during several time periods (504) into a prediction model in “learning” mode (e.g., at least at a time point close to admission when the patient is in a bad state, at a time point close to release from the hospital when the patient is in the best state achievable (506), etc.). During each of the time periods, the treating physician may additionally or alternatively enter the physician's assessment of the disease status as a score between 1 and 10 into the prediction model in learning mode. The inputs may be utilized to modify the prediction model to generate an individual-specific prediction model associated with the patient. The modification to the prediction model may, for instance, be performed continuously in accordance with one or more criteria (e.g., after each set of observables entered, after one or more of the observable sets are entered, etc.).

Based on personalization of the prediction model, co-morbidities may be taken into account when using the prediction model to generate determinations with respect to the heart failure patient. For example, if the patient also has kidney disease (e.g., due to the patient also having diabetes), the personalized prediction model may learn that a certain level of reduced kidney function in this patient is not due to heart failure (e.g., if the reduced kidney function is still present at the time of release from the hospital when the physician has entered his/her judgement of the patient's heart status as satisfactory for hospital release (e.g., a score indicating that the patient no longer needs to be in the hospital for heart problems). When the patient goes home, the treating medical specialist may tell the patient that he has to continue taking his drugs and would like to have him to provide his observables every 2 or 3 days, such as his weight, heart rate, respiratory rate, pitting edema at the ankles, and fill in a questionnaire with symptoms (e.g., normal daily activities the patient has trouble performing because of fatigue, severity of the patient's nausea, shortness of breath when the patient is walking one flight of stairs, severity of the patient's orthopnea, how often the patient must get up to urinate at night, etc.). These observables are provided as input to the personalized prediction model (508), and the output of the prediction model (e.g., probability of heart failure or other health status) may be provided to the patient, the patient's general practitioner, the patient's medical specialist, or other individual (510).

As an example, after some time, the prediction model may flag an alert as a result of a prediction of an increasing probability of heart failure (e.g., over 50%) (512). Based on the alert, a visualization that may be presented (e.g., to the patient's physician or other individual) may show that the left part of the heart is probably failing and that observables primarily responsible for the left heart failure are pitting edema, weight gain, increasing nycturia, and orthopnea. Based on the alert, the prediction model may additionally or alternative suggest to the patient's physician to obtain certain additional observable information (e.g., oxygen saturation, a sodium determination, etc.) to increase the reliability of the probability prediction.

When the additional observable information is provided to the prediction model (e.g., automatically via health monitoring devices at home, a lab, a hospital, etc., or manually entered by the physician or other individual based on his/her observables of the patient) (514), a probability of exacerbation of heart failure may be confirmed. Additionally, or alternatively, the prediction model may alert to the patient's reduced kidney function which is co-occurring with the exacerbation of heart failure (e.g., and may be relevant for decisions on changing drug regimen). Based on this alert, the patient's physician (e.g., general practitioner, medical specialist, etc.) may recommend increasing ACE blocker (angiotensin-converting-enzyme blocker). The prediction model may continue to monitor the patient's health status, and any improvements or exacerbation may be automatically entered into the patient's electronic medical record.

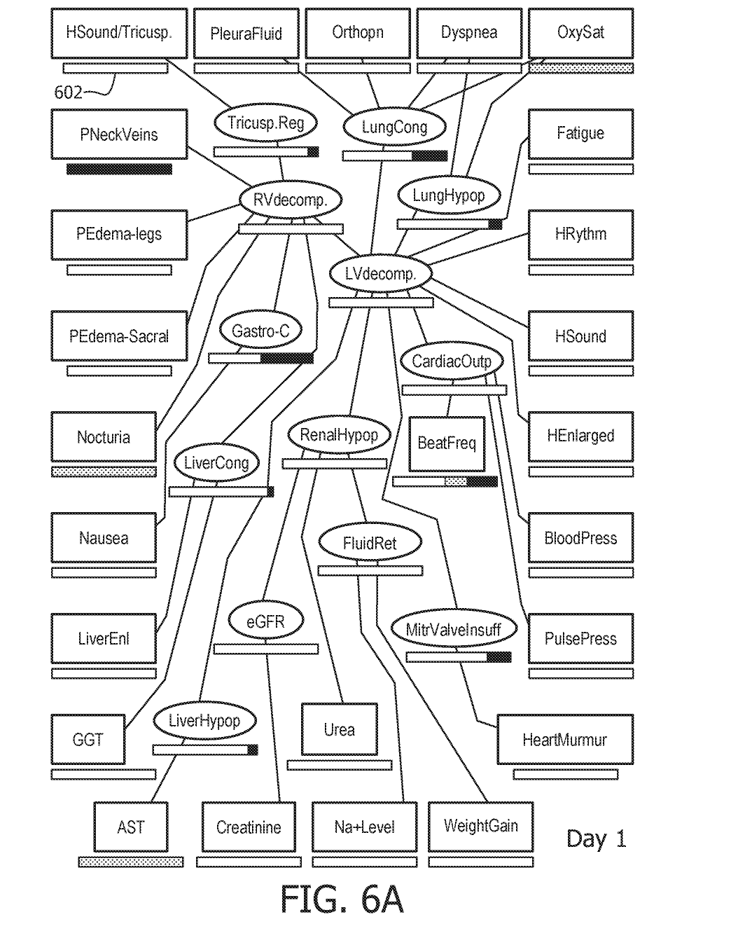

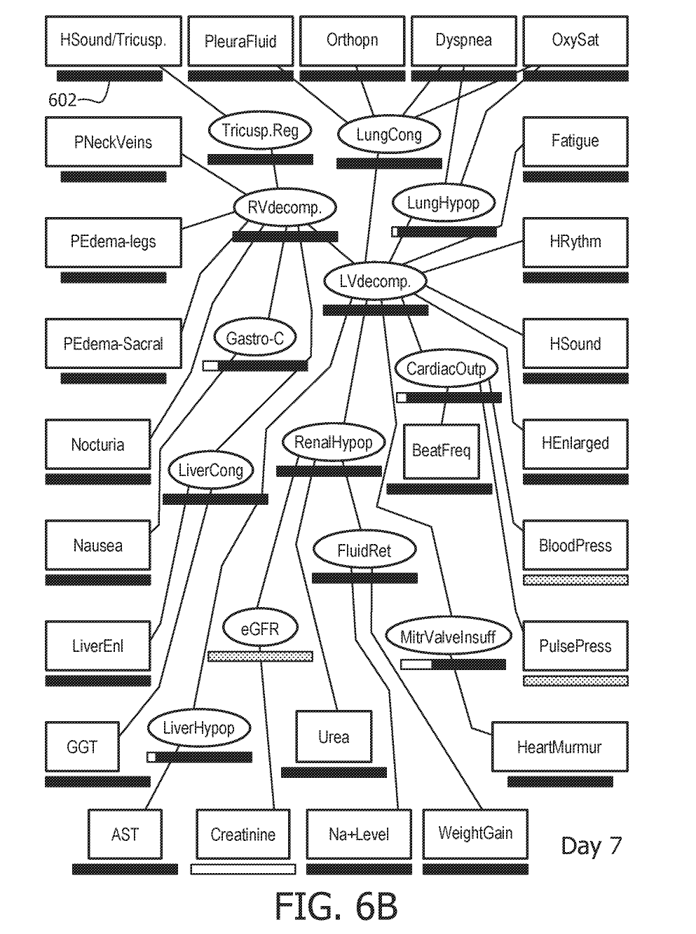

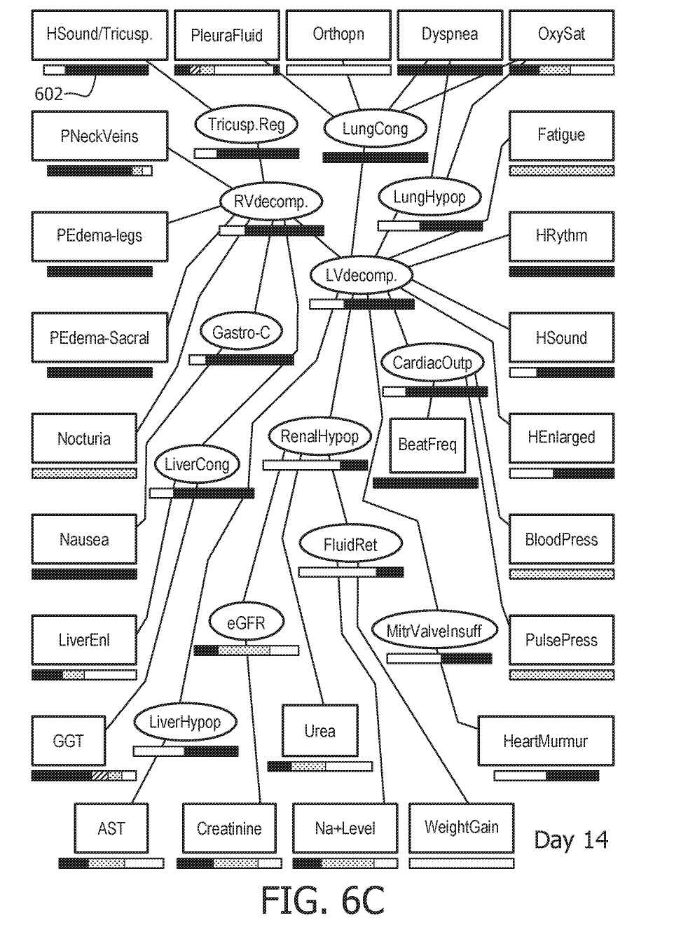

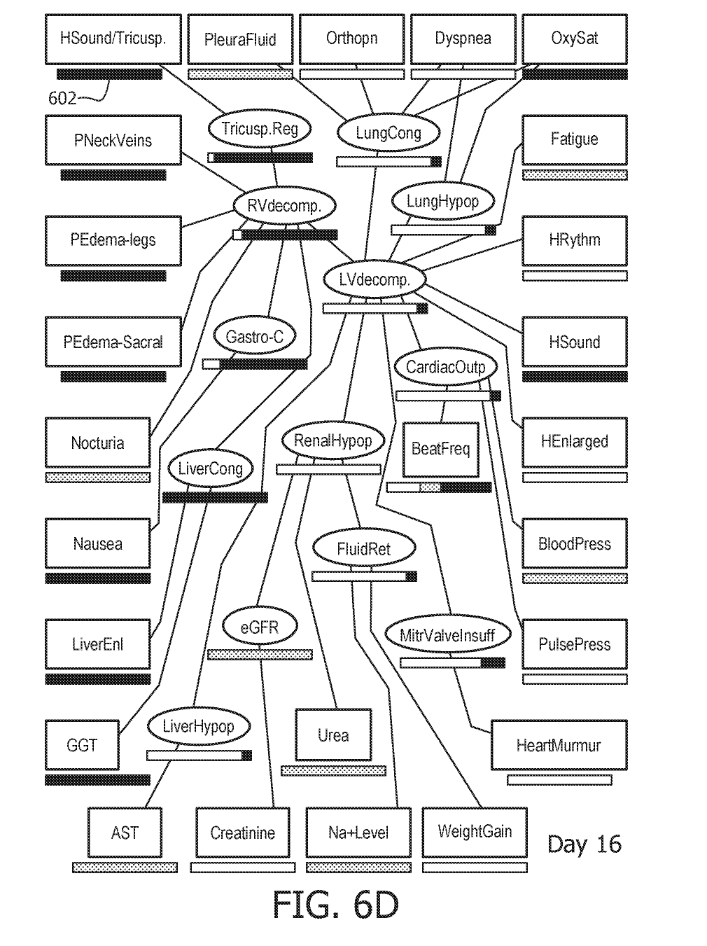

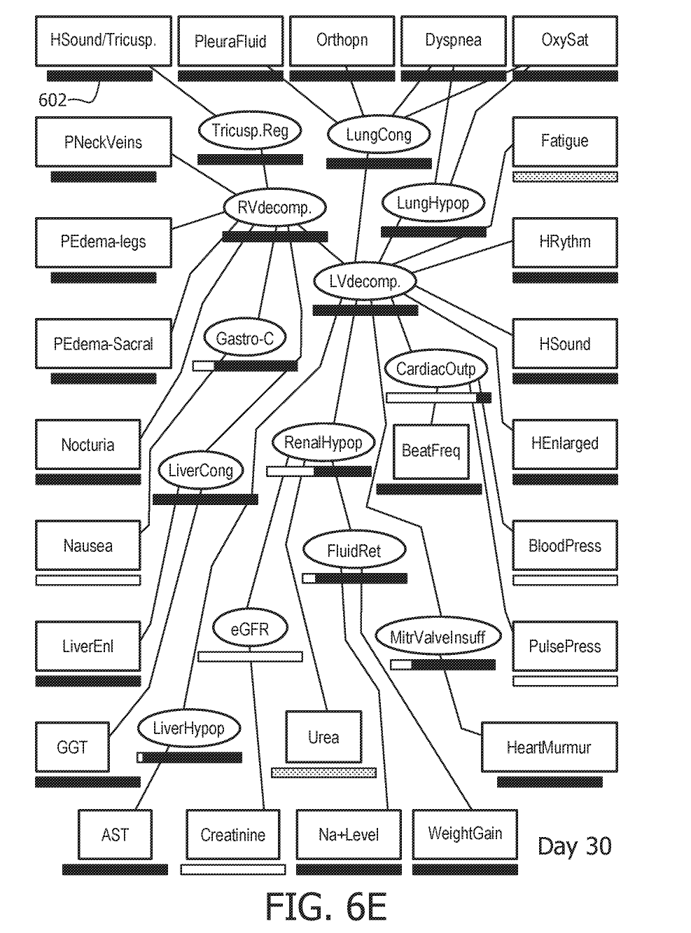

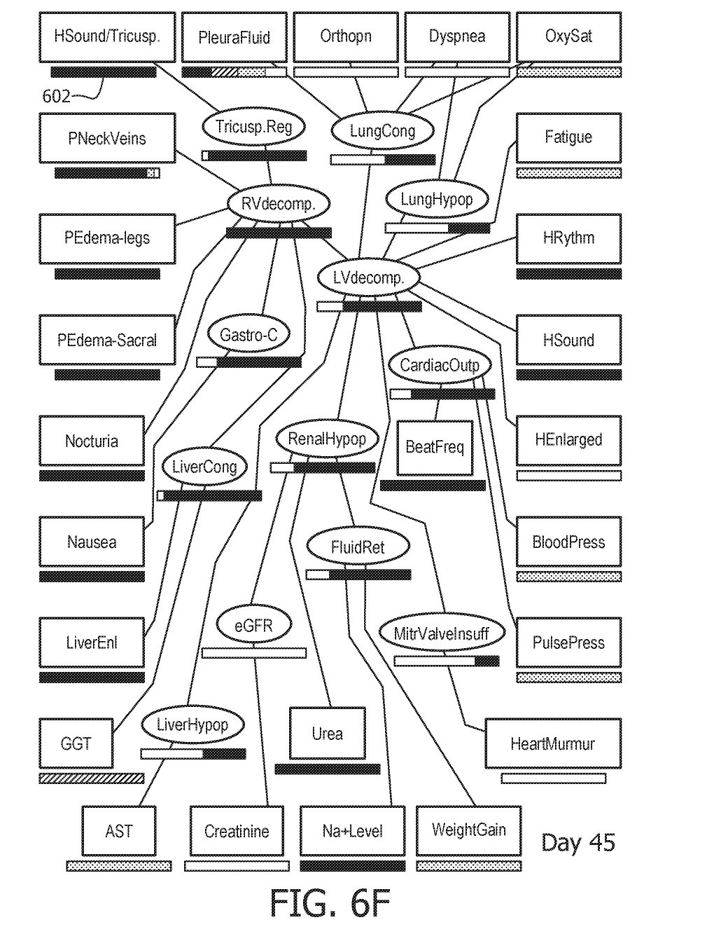

FIGS. 6A-6F show a use case of an individual and observables thereof at various points in time, in accordance with one or more implementations. With respect to FIGS. 6A-6F, each node representing an observable of the individual is associated with a representative bar (e.g., one of the bars 602), where the bar represents an observed measurement or health condition of the individual or probabilities of measurements or health conditions of the individual. As an example, a bar may be subdivided into different patterned/solid sections according to the probabilities that the node has the corresponding value (or range thereof). If the value of the node has been set according to a measurement or health condition that has been observed, the bar will not be subdivided (e.g., showing only one patterned/solid section). As a further example, lighter bar sections may represent values (or range) that are worse than the values (or range) of darker bar sections of the same bar. As such, a bar section with a black solid fill may represent the best value for the individual, a bar section with a white solid fill of the same bar may represent the worst value for the individual, and a bar section with a patterned fill may represent a value in between the worst and best values for the individual (e.g., where a darker patterned fill may represent a value better than a value represented by a lighter patterned fill).

As an example, with respect to FIGS. 6A-6F, round nodes 602 may represent conditions of the individual derived from other inputs from other round nodes 602 or rectangular nodes 604, and the rectangular nodes 604 may represent measurements or other observables. Nodes 602 may represent decompensated left heart failure, decompensated right heart failure, cardiac output, lung congestion, lung hypoperfusion, renal hypoperfusion, tricuspedalic regurgitation, gastrointestinal congestion, liver congestion, liver hypoperfusion, eGFR, fluid retention, mitralic valve insufficiency, or other conditions (or other observables). Nodes 604 may represent creatinine level, weight gain, sodium level, beating frequency, pulse pressure, systolic blood pressure, heart rhythm, heart sound, enlarged heart, fatigue, dyspnea, heart murmur, urea nitrogen levels, AST, oxygen saturation, orthopnea, pleura fluid, GGT, liver tender enlargement, nausea, prominent neck veins, pitting edema (e.g., symmetrical ankle/pretibial, sacral, etc.), nycturia, heart sound tricuspedalic valve, or other observables.

In one use case, the state of nodes 602 and 604 shown in FIG. 6A may represent the state of the individual (e.g., “Day 1”) when the individual is admitted to a hospital (or other clinical setting) while in a bad state where most of the observables are in their worst (or near worst) possible range for the individual. The state of nodes 602 and 604 shown in FIG. 6B may represent the state of the individual (e.g., “Day 7”) at the time that the individual is released from the hospital (or other clinical setting) when the individual is well again except for an elevated creatinine level and a consequently lowered eGFR—which may be unrelated to his heart failure, but due to a common comorbidity such as diabetes. As shown in FIGS. 6A-6B, all of the observables represented by nodes 604 are available for observation, which may result in the probability predictions for the decompensation of the ventricles to be very accurate.

The state of nodes 602 and 604 shown in FIG. 6C may represent the state of the individual (e.g., “Day 14”) when the individual is showing signs of a worsening heart failure condition at home (or other setting). As shown in FIG. 6C, some of the observables available for observation in the setting corresponding to FIGS. 6A-6B may not be available for observation at home (or other setting where such observation is more limited). Nevertheless, in some use cases, when computing the probability for left/right ventricular decompensation, one or more of the observables that are not available for observation may be assigned a certain probability distribution based on the available observables (e.g., in accordance with one or more prediction models described herein). As an example, although creatinine level, sodium level, heart sound, enlarged heart, heart murmur, urea nitrogen levels, AST, oxygen saturation, pleura fluid, GGT, liver tender enlargement, prominent neck veins, heart sound tricuspedalic valve, or other observables may not be readily determined (e.g., lack of corresponding health monitoring devices and/or such observables cannot be accurately determined without such health monitoring devices), one or more of the unavailable observables may nonetheless be assigned a probability distribution based on one or more of the available observables and the prediction model (e.g., an individual-specific Bayesian or other prediction model). The prediction model may, for instance, enable meaningful conclusions to be derived from the available information (e.g., available observables) to predict the probability for left/right ventricular decompensation.

In a further use case, additional health monitoring devices and/or sensors may be provided to extend the available data set in the home or other limited setting. For example, some lab values as the serum Na concentration or creatinine could be measured from a blood droplet or a measure for pleura fluid could be obtained from a thorax impedance measurement. In one scenario, if a worsening value for left/right ventricular decompensation is predicted based on a limited set of available observables, additional health monitoring devices and/or sensors may be used to obtain a more precise value (or otherwise confirm the prediction based on the limited set of available observables).

The state of nodes 602 and 604 shown in FIG. 6D may represent the state of the individual (e.g., “Day 16”) at the time that the individual is readmitted to the hospital (or other clinical setting). The state of nodes 602 and 604 shown in FIG. 6E may represent the state of the individual (e.g., “Day 30”) when the individual is having some complications related to dehydration (e.g., due to diarrhea, gastrointestinal infection, etc.). Based on the prediction model knowing that the individual's nausea and low cardiac output may be from dehydration and/or the individual's known decreased kidney function, the system may predict that the individual is no longer suffering from left/right ventricular decompensation.

The state of nodes 602 and 604 shown in FIG. 6F may represent the state of the individual (e.g., “Day 45”) when the individual is having some complications from pneumonia (e.g., induced by chronic obstructive pulmonary disease or other factor). As shown in FIG. 6F, the individual appears to have decreased lung function and the usual impaired kidney function. Although pleurafluid is present, the prediction model may indicate that the pleurafluid may be due to local inflammation associated with pneumonia rather than increased venous pressure. Other non-optimal conditions of the individual may include non-optimal liver biomarkers, a heart murmur indicative of an insufficiency of the mitralic valve, an early sign of impending heart failure exacerbation due to the fever and hypoxia associated with pneumonia, an enlarged heart, etc. Based on the foregoing, the prediction model may indicate that there is some non-vanishing probability for a left ventricular decompensation (but far from being certain).

Examples Flowcharts

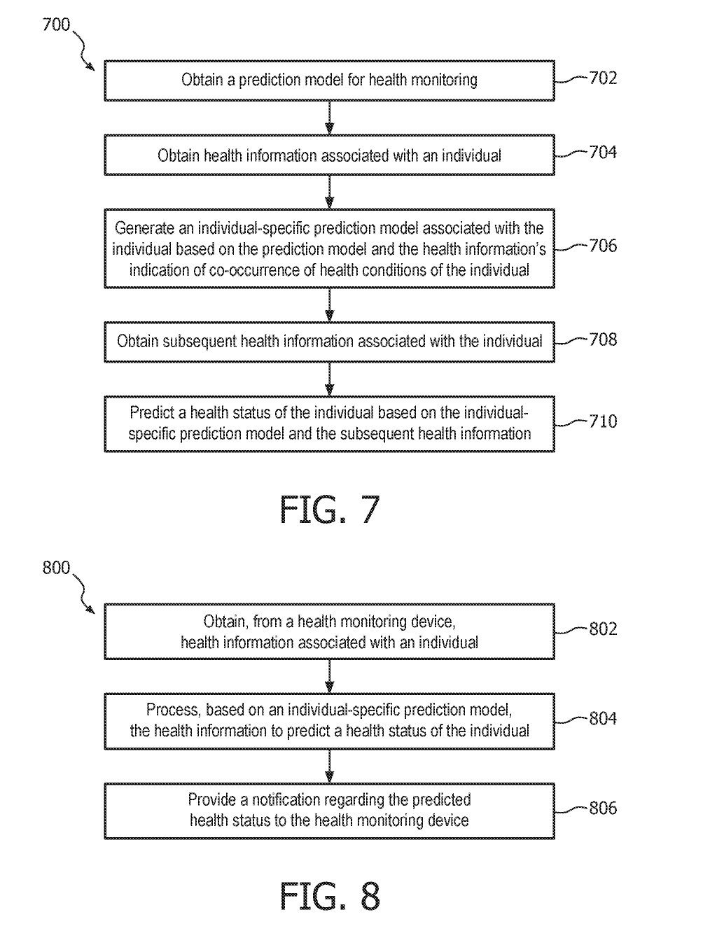

FIGS. 7-11 comprise example flowcharts of processing operations of methods that enable the various features and functionality of the system as described in detail above. The processing operations of each method presented below are intended to be illustrative and non-limiting. In some implementations, for example, the methods may be accomplished with one or more additional operations not described, and/or without one or more of the operations discussed. Additionally, the order in which the processing operations of the methods are illustrated (and described below) is not intended to be limiting.

In some implementations, the methods may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on an electronic storage medium. The processing devices may include one or more devices configured through hardware, firmware, and/or software to be specifically designed for execution of one or more of the operations of the methods.

FIG. 7 shows a flowchart of a method 700 of facilitating health monitoring of an individual based on an individual-specific prediction model, in accordance with one or more implementations.

In an operation 702, a prediction model for health monitoring may be obtained. Operation 702 may be performed by a model management subsystem that is the same as or similar to model management subsystem 112, in accordance with one or more implementations.

In an operation 704, health information associated with an individual may be obtained. As an example, the health information may indicate a co-occurrence of health conditions of the individual (e.g., determined based on measurements of the individual). Operation 704 may be performed by a health information management subsystem that is the same as or similar to health information management subsystem 114, in accordance with one or more implementations.

In an operation 706, an individual-specific prediction model associated with the individual may be generated based on the prediction model and the co-occurrence indication. Operation 706 may be performed by a model management subsystem that is the same as or similar to model management subsystem 112, in accordance with one or more implementations.

In an operation 708, subsequent health information associated with the individual may be obtained. As an example, the subsequent health information may indicate (i) subsequent measurements of the individual observed after the co-occurrence of the health conditions, (ii) subsequent health conditions of the individual (e.g., determined based on the subsequent measurements), or (iii) other information. Operation 708 may be performed by a health information management subsystem that is the same as or similar to health information management subsystem 114, in accordance with one or more implementations.

In an operation 710, a health status of the individual may be predicted based on the individual-specific prediction model and the subsequent health information. Operation 710 may be performed by a prediction subsystem that is the same as or similar to prediction management subsystem 116, in accordance with one or more implementations.

FIG. 8 shows a flowchart of a method 800 of facilitating health monitoring of an individual and predicted health status notification via a health monitoring device, in accordance with one or more implementations.

In an operation 802, health information associated with an individual may be obtained from a health monitoring device. The health information may indicate (i) measurements of the individual, (ii) health conditions of the individual (e.g., determined based on the measurements), or (iii) other information. Operation 802 may be performed by a health information management subsystem that is the same as or similar to health information management subsystem 114, in accordance with one or more implementations.

In an operation 804, the health information may be processed based on an individual-specific prediction model to predict a health status of the individual. As an example, the individual-specific prediction model may be generated based on prior measurements of the individual, prior health conditions of the individual (e.g., determined based on the prior measurements), or other information. A prediction model for predicting health status may, for instance, be modified based on the prior measurements and/or the prior health conditions to generate the individual-specific prediction model. The individual-specific prediction model may comprise modified versions of parameters of the unmodified prediction model, parameters not included in the unmodified prediction model, or other parameters. Operation 804 may be performed by a health information management subsystem that is the same as or similar to health information management subsystem 114, in accordance with one or more implementations.

In an operation 806, a notification regarding the predicted health status may be provided to the health monitoring device. As an example, the notification may be provided such that the predicted health status may be presented via a output device of the health monitoring device (e.g., a display screen, an audio output device, or other output device). Operation 806 may be performed by a notification subsystem that is the same as or similar to notification subsystem 118, in accordance with one or more implementations.

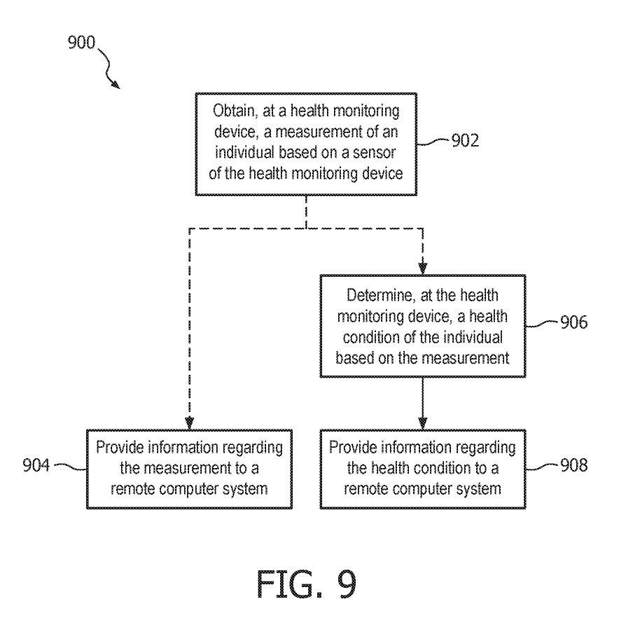

FIG. 9 shows a flowchart of a method 900 of facilitating health monitoring of an individual at a health monitoring device via a remote computer system, in accordance with one or more implementations.

In an operation 902, a measurement of an individual may be obtained at a health monitoring device (e.g., based on information from a sensor of the health monitoring device). Operation 902 may be performed by a health monitoring device that is the same as or similar to health monitoring device 106, in accordance with one or more implementations.

In an operation 904, information regarding the measurement of the individual may be provided to a remote computer system. As an example, the health monitoring device may be a local health monitoring device for collecting and/or processing measurements of the individual, and the collected measurements may be provided to the remote computer system for processing (e.g., to predict a health status of the individual based on an individual-specific prediction model and the collected measurements). Operation 904 may be performed by a health monitoring device that is the same as or similar to health monitoring device 106, in accordance with one or more implementations.

In an operation 906, a health condition of the individual may be determined at the health monitoring device based on the measurement (obtained based on information from the sensor of the health monitoring device). Operation 906 may be performed by a health monitoring device that is the same as or similar to health monitoring device 106, in accordance with one or more implementations.

In an operation 908, information regarding the health condition of the individual may be provided to a remote computer system. As an example, the health monitoring device may be a local health monitoring device for collecting and/or processing measurements of the individual, and, upon determination of health conditions of the individual based on the collected measurements, the health conditions may be provided to the remote computer system for processing (e.g., to predict a health status of the individual based on an individual-specific prediction model and the health conditions). Operation 908 may be performed by a health monitoring device that is the same as or similar to health monitoring device 106, in accordance with one or more implementations.

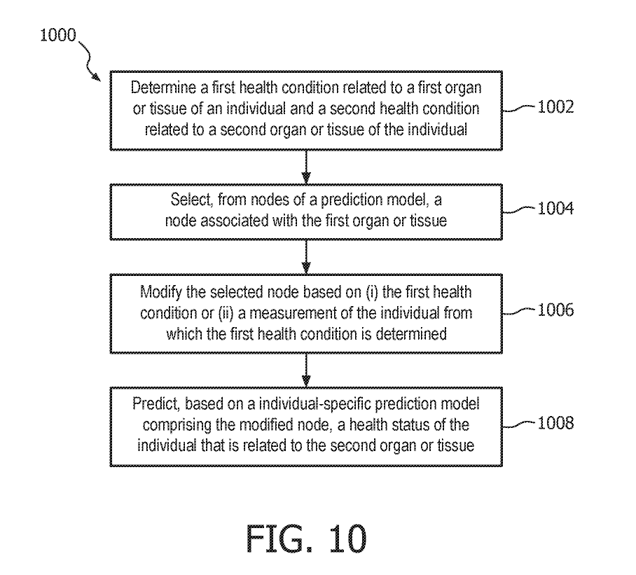

FIG. 10 shows a flowchart of a method 1000 of generating an individual-specific prediction model for predicting a health status of an individual, in accordance with one or more implementations.

In an operation 1002, a first health condition related to a first organ or tissue of the individual, a second health condition related to a second organ or tissue of the individual, or other health condition of the individual may be determined. As an example, the first and second health conditions may be determined based on health information obtained from one or more health monitoring devices. The health information (obtained from the health monitoring devices) may indicate measurements of the individual collected via sensors of the health monitoring devices, health conditions (e.g., determined based on the collected measurements), or other information. Additionally, or alternatively, the health information may indicate a co-occurrence of health conditions of the individual such as an indication of a co-occurrence of the first and second health conditions. Operation 1002 may be performed by a health information management subsystem that is the same as or similar to health information management subsystem 114, in accordance with one or more implementations.

In an operation 1004, a node associated with one of the organs or tissues (e.g., the first organ or tissue) may be selected from nodes of a prediction model. As an example, the node may be modified to generate an individual-specific prediction model for predicting a health status of the individual that is related to another one of the organs or tissues (e.g., the second organ or tissue). Operation 1004 may be performed by a model management subsystem that is the same as or similar to model management subsystem 112, in accordance with one or more implementations.

In an operation 1006, the selected node may be modified based on (i) the first health condition or (ii) a measurement of the individual from which the first health condition is determined. Operation 1006 may be performed by a model management subsystem that is the same as or similar to model management subsystem 112, in accordance with one or more implementations.

In an operation 1008, a health status of the individual (that is related to the second organ or tissue) may be predicted based on an individual-specific prediction model comprising the modified node. As an example, the individual-specific prediction model and subsequent health information (e.g., obtained from one or more health monitoring devices) may be utilized to predict the health status of the individual. Operation 1008 may be performed by a prediction subsystem that is the same as or similar to prediction subsystem 116, in accordance with one or more implementations.

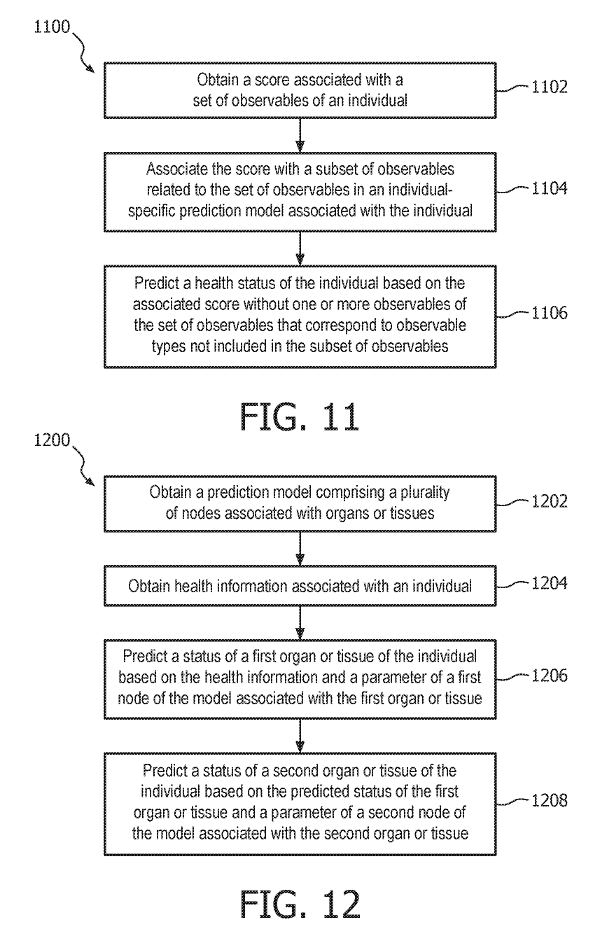

FIG. 11 shows a flowchart of a method 1100 of facilitating health monitoring of an individual without one or more measurements of an individual, in accordance with one or more implementations.

In an operation 1102, a score associated with a set of observables (e.g., measurements, health conditions, etc.) of an individual may be obtained. Operation 1102 may be performed by a model management subsystem that is the same as or similar to model management subsystem 112, in accordance with one or more implementations.

In an operation 1104, the score may be associated with a subset of observables (related to the set of observables) in an individual-specific prediction model associated with the individual. As an example, the subset of observables may comprise a fewer number of types of observables than the number of types of observables of the set of observables. Upon association, for instance, the score may be used to generate a prediction based on observables of the individual that correspond to the types of observables of the subset (e.g., as opposed to requiring observables for all of the types of observables of the set of observables with which the score is initially associated). Operation 1104 may be performed by a model management subsystem that is the same as or similar to model management subsystem 112, in accordance with one or more implementations.

In an operation 1106, a health status of the individual may be predicted based on the associated score without one or more observables of the set of observables that correspond to types of observables not included in the subset of observables. As an example, after the association of the score with the subset of observables, the individual's health information may be obtained (e.g., from one or more health monitoring devices) and compared against the subset of observables to determine a health status score. If, for instance, the obtained health information comprises the latest observables of the individual, and these latest observables are similar or fall within range of the subset of observables, the score may be used as the health status score or weighted heavily in calculating the health status score. On the other hand, if the latest observables are not similar or do not fall within range of the subset of observables, the score may be weighted lightly (or have no weight) in calculating the health status score. As indicated, in some implementations, one or more observables (or observable types thereof) on which determination of the associated score was based may not be needed to predict the health status of the individual using the associated score. Operation 1106 may be performed by a prediction subsystem that is the same as or similar to prediction subsystem 116, in accordance with one or more implementations.

FIG. 12 shows a flowchart of a method 1200 of facilitating health monitoring of an individual with respect to one organ or tissue based on a predicted status of another organ or tissue, in accordance with one or more implementations.

In an operation 1202, a prediction model comprising a plurality of nodes associated with organs or tissues may be obtained. The nodes may comprise a first node associated with a first organ or tissue, a second node associated with a second organ or tissue, or other nodes associated with other organs or tissues. Operation 1202 may be performed by a model management subsystem that is the same as or similar to model management subsystem 112, in accordance with one or more implementations.

In an operation 1204, health information associated with an individual may be obtained. The health information may comprise measurements of the individual, health conditions of the individual, or other health information. Operation 1204 may be performed by a health information management subsystem that is the same as or similar to health information management subsystem 114, in accordance with one or more implementations.

In an operation 1206, a status of the first organ or tissue of the individual may be predicted based on the health information and a parameter of the first node associated with the first organ or tissue. Operation 1206 may be performed by a prediction subsystem that is the same as or similar to prediction subsystem 116, in accordance with one or more implementations.

In an operation 1208, a status of the second organ or tissue may be predicted based on the predicted status of the first organ or tissue and a parameter of the second node associated with the second organ or tissue. Operation 1208 may be performed by a prediction subsystem that is the same as or similar to prediction subsystem 116, in accordance with one or more implementations.

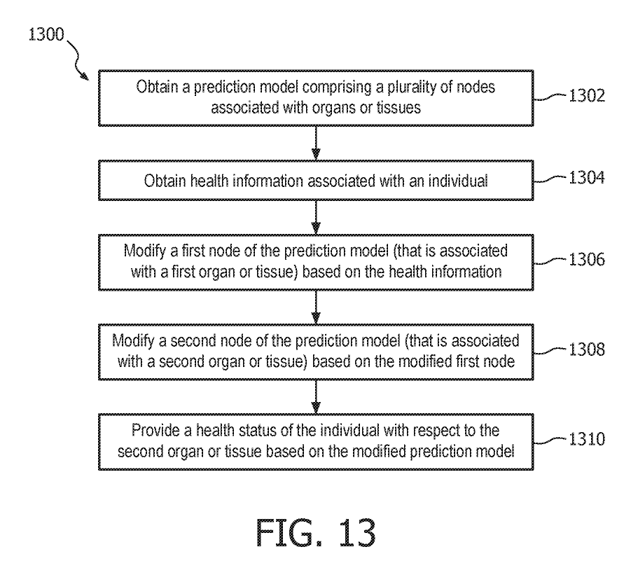

FIG. 13 shows a flowchart of a method 1300 of facilitating health monitoring of an individual with respect to one organ or tissue based on a predicted status of another organ or tissue, in accordance with one or more implementations.

In an operation 1302, a prediction model comprising a plurality of nodes associated with organs or tissues may be obtained. The nodes may comprise a first node associated with a first organ or tissue, a second node associated with a second organ or tissue, or other nodes associated with other organs or tissues. Operation 1302 may be performed by a model management subsystem that is the same as or similar to model management subsystem 112, in accordance with one or more implementations.

In an operation 1304, health information associated with an individual may be obtained. The health information may comprise measurements of the individual, health conditions of the individual, or other health information. Operation 1304 may be performed by a health information management subsystem that is the same as or similar to health information management subsystem 114, in accordance with one or more implementations.

In an operation 1306, the first node associated with the first organ or tissue may be modified based on the health information. Operation 1306 may be performed by a model management subsystem that is the same as or similar to model management subsystem 112, in accordance with one or more implementations.

In an operation 1308, the second node associated with the second organ or tissue may be modified based on the modified first node. Operation 1308 may be performed by a model management subsystem that is the same as or similar to model management subsystem 112, in accordance with one or more implementations.

In an operation 1310, a health status of the individual with respect to the second organ or tissue may be provided based on the modified prediction model. Operation 1310 may be performed by a prediction subsystem that is the same as or similar to prediction subsystem 116, in accordance with one or more implementations.

In some implementations, the various computers and subsystems illustrated in FIG. 1 may comprise one or more computing devices that are programmed to perform the functions described herein. The computing devices may include one or more electronic storages (e.g., prediction model database 132, health information database 134, or other electric storages), one or more physical processors programmed with one or more computer program instructions, and/or other components. The computing devices may include communication lines or ports to enable the exchange of information with a network (e.g., network 150) or other computing platforms via wired or wireless techniques (e.g., Ethernet, fiber optics, coaxial cable, WiFi, Bluetooth, near field communication, or other technologies). The computing devices may include a plurality of hardware, software, and/or firmware components operating together to provide the functionality attributed herein to the servers. For example, the computing devices may be implemented by a cloud of computing platforms operating together as the computing devices.

The electronic storages may comprise non-transitory storage media that electronically stores information. The electronic storage media of the electronic storages may include one or both of system storage that is provided integrally (e.g., substantially non-removable) with the servers or removable storage that is removably connectable to the servers via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information received from the servers, information received from client computing platforms, or other information that enables the servers to function as described herein.

The processors may be programmed to provide information processing capabilities in the servers. As such, the processors may include one or more of a digital processor, an analog processor, a digital circuit designed to process information, an analog circuit designed to process information, a state machine, and/or other mechanisms for electronically processing information. In some implementations, the processors may include a plurality of processing units. These processing units may be physically located within the same device, or the processors may represent processing functionality of a plurality of devices operating in coordination. The processors may be programmed to execute computer program instructions to perform functions described herein of subsystems 112-118 or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems 112-118 described herein is for illustrative purposes, and is not intended to be limiting, as any of subsystems 112-118 may provide more or less functionality than is described. For example, one or more of subsystems 112-118 may be eliminated, and some or all of its functionality may be provided by other ones of subsystems 112-118. As another example, additional subsystems may be programmed to perform some or all of the functionality attributed herein to one of subsystems 112-118.

Although the present invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the scope of the appended claims. For example, it is to be understood that the present invention contemplates that, to the extent possible, one or more features of any implementation can be combined with one or more features of any other implementation.

What is claimed is:

1. A system for facilitating health monitoring of individuals based on individual-specific prediction models, the system comprising:
a computer system that comprises one or more physical processors programmed with computer program instructions which, when executed, cause the computer system to:
obtain a prediction model for health monitoring;
obtain health information associated with an individual, wherein the health information indicates a co-occurrence of health conditions of the individual;
generate an individual-specific prediction model associated with the individual based on the prediction model and the co-occurrence indication;
obtain subsequent health information associated with the individual, wherein the subsequent health information indicates one or more of (i) subsequent measurements of the individual observed after the co-occurrence of the health conditions or (ii) subsequent health conditions of the individual observed after the co-occurrence of the health conditions;
predict a health status of the individual based on the individual-specific prediction model and the subsequent health information.

2. The system of claim 1, further comprising:
one or more remote health monitoring devices, each of which comprises one or more sensors programmed to collect health-related sensor data, and one or more physical processors programmed with computer program instructions which, when executed, cause the remote health monitoring device to:
obtain, based on the sensors, at least one of the subsequent measurements of the individual;
determine at least one of the subsequent health conditions of the individual based on the at least one subsequent measurement; and
provide information regarding the at least one health condition to the computer system,
wherein the computer system obtains the subsequent health information by obtaining the information regarding the at least one health condition from the remote health monitoring devices.

3. The system of claim 2, wherein the computer system is further caused to:
provide a notification regarding the predicted health status to at least one of the remote health monitoring devices.

4. The system of claim 1, further comprising:
one or more remote health monitoring devices, each of which comprises one or more sensors programmed to collect health-related sensor data, and one or more physical processors programmed with computer program instructions which, when executed, cause the remote health monitoring device to:
obtain, based on the sensors, at least one of the subsequent measurements of the individual; and
provide information regarding the at least one subsequent measurement to the computer system, wherein the computer system obtains the subsequent health information by obtaining the information regarding the at least one subsequent measurement from the remote health monitoring devices.

5. The system of claim 4, wherein the computer system is further caused to:
provide a notification regarding the predicted health status to at least one of the remote health monitoring devices.

6. The system of claim 1, wherein the computer system generates the individual-specific prediction model associated with the individual by:
modifying the prediction model to include one or more parameters based on the co-occurrence indication,
wherein the individual-specific prediction model comprises one or more of modified versions of parameters of the unmodified prediction model or parameters not included in the unmodified prediction model.

7. The system of claim 6, wherein the prediction model comprises a graph having a plurality of nodes associated with organs or tissues, and the health conditions of the individual comprises a first health condition related to a first organ or tissue that co-occurred with a second health condition related to a second organ or tissue, and wherein the computer system modifies the prediction model by:
selecting a first node of the prediction model to be modified, wherein the first node is associated with the first organ or tissue, and wherein the predicted health status comprises a prediction related to the second organ or tissue; and
modifying the selected first node based on one or more of: (i) the first health condition of the individual; or (ii) a measurement of the individual from which the first health condition is determined,
wherein the individual-specific prediction model comprises the modified first node.

8. The system of claim 7, wherein the first organ or tissue is a first organ, and the second organ or tissue is a second organ.

9. The system of claim 7, wherein the first organ or tissue is a first tissue, and the second organ or tissue is a second tissue.

10. The system of claim 7, wherein the first organ or tissue is a tissue, and the second organ or tissue is an organ, or wherein the first organ or tissue is the organ, and the second organ or tissue is the tissue.

11. The system of claim 1, wherein the health information indicates sets of measurements of the individual or health conditions of the individual, and wherein the computer system is further caused to:
obtain score information associated with the individual, wherein the score information indicates a score for each of the sets of measurements or health conditions indicated by the health information,
wherein the computer system generates the individual-specific prediction model by associating a first score of the indicated scores with a first subset of measurements or health conditions related to a first set of the sets of measurements or health conditions,
wherein the first set of measurements comprises a number of types of measurements or health conditions, and wherein the first subset of measurements comprises fewer types of measurements or health conditions than the number of types of measurements or health conditions of the first set, and
wherein the subsequent measurements or health conditions comprise fewer types of measurements or health conditions than the number of types of measurements or health conditions of the first set, and wherein the first score is used to predict the health status of the individual.

12. The system of claim 11, wherein each of the sets of measurements or health conditions is associated with a score related to a morbid event sustained by the individual, and
wherein predicting the health status of the individual comprises using the first score to predict the likelihood that the individual will re-sustain the morbid event.

13. The system of claim 1, wherein the health status prediction comprises a prediction of likelihood that the individual will sustain or re-sustain a morbid event.

14. The system of claim 13, wherein the morbid event comprises one or more of heart failure, kidney failure, liver failure, respiratory failure, transient ischemic attack, or stroke.

15. The system of claim 1, wherein the health status prediction comprises a prediction of a change in status of a chronic disease of the individual.

16. The system of claim 15, wherein the change in status comprises one or more of an exacerbation related to the chronic disease or an improvement related the chronic disease.

17. The system of claim 1, wherein the co-occurring health conditions of the individual comprises two or more diseases co-occurring in the individual, the individual-specific prediction model is related to predicting a status related to one of the co-occurring diseases, and one or more parameters of the individual-specific prediction model are configured based on the presence of at least another one of the co-occurring diseases, and
wherein the computer system predicts the health status of the individual by predicting the status of the one of the co-occurring diseases based on the configured parameters of the individual-specific prediction model and the subsequent health information.

18. The system of claim 17, wherein the co-occurring diseases have one or more symptoms in common with one another.

19. The system of claim 1, wherein the co-occurring health conditions of the individual comprises two or more normal population variants co-occurring in the individual, the individual-specific prediction model is related to predicting a status related to one of the co-occurring normal population variants, and one or more parameters of the individual-specific prediction model are configured based on the presence of at least another one of the co-occurring normal population variants, and
wherein the computer system predicts the health status of the individual by predicting the status of the one of the co-occurring normal population variants based on the configured parameters of the individual-specific prediction model and the subsequent health information.

20. The system of claim 19, wherein the co-occurring normal population variants have one or more symptoms in common with one another.

21. The system of claim 1, wherein the prediction model comprises a Bayesian model, and the individual-specific prediction model comprises an individual-specific Bayesian model associated with the individual.

22. A method of facilitating health monitoring of individuals based on individual-specific prediction models, the method being implemented by a computer system that comprises one or more physical processors executing computer program instructions which, when executed, perform the method, the method comprising:
obtaining, by the computer system, a prediction model for health monitoring;
obtaining, by the computer system, health information associated with an individual, wherein the health information indicates a co-occurrence of health conditions of the individual;
generating, by the computer system, an individual-specific prediction model associated with the individual based on the prediction model and the co-occurrence indication;
obtaining, by the computer system, subsequent health information associated with the individual, wherein the subsequent health information indicates one or more of: (i) subsequent measurements of the individual observed after the co-occurrence of the health conditions; or (ii) subsequent health conditions of the individual observed after the co-occurrence of the health conditions; and
predicting, by the computer system, a health status of the individual based on the individual-specific prediction model and the subsequent health information.

23. The method of claim 22, wherein the subsequent health information is obtained by:
obtaining, by the computer system, from one or more remote health monitoring devices comprising one or more sensors, at least one of the subsequent measurements of the individual observed by the sensors; and
determining, by the computer system, at least one of the subsequent health conditions of the individual based on the at least one subsequent measurement from the remote health monitoring devices.

24. The method of claim 22, wherein the subsequent health information is obtained by:
obtaining, by the computer system, from one or more remote health monitoring devices comprising one or more sensors, at least one of the subsequent health conditions of the individual.

25. The method of claim 22, wherein the individual-specific prediction model associated with the individual is generated by:
modifying, by the computer system, the prediction model to include one or more parameters based on the co-occurrence indication,
wherein the individual-specific prediction model comprises one or more of modified versions of parameters of the unmodified prediction model or parameters not included in the unmodified prediction model.

26. The method of claim 25, wherein the prediction model comprises a graph having a plurality of nodes associated with organs or tissues, and the health conditions of the individual comprises a first health condition related to a first organ or tissue that co-occurred with a second health condition related to a second organ or tissue, and wherein the prediction model is modified by:
selecting, by the computer system, a first node of the prediction model to be modified, wherein the first node is associated with the first organ or tissue, and wherein the predicted health status comprises a prediction related to the second organ or tissue; and
modifying, by the computer system, the selected first node based on one or more of: (i) the first health condition of the individual; or (ii) a measurement of the individual from which the first health condition is determined,
wherein the individual-specific prediction model comprises the modified first node.

27. The method of claim 22, wherein the health information indicates sets of measurements of the individual, the method further comprising:
obtaining, by the computer system, score information associated with the individual, wherein the score information indicates a score for each of the sets of measurements or health conditions indicated by the health information,
wherein the computer system generates the individual-specific prediction model by associating a first score of the indicated scores with a first subset of measurements or health conditions related to a first set of the sets of measurements or health conditions,
wherein the first set of measurements comprises a number of types of measurements or health conditions, and wherein the first subset of measurements comprises fewer types of measurements or health conditions than the number of types of measurements or health conditions of the first set, and
wherein the subsequent measurements or health conditions comprise fewer types of measurements or health conditions than the number of types of measurements or health conditions of the first set, and wherein the first score is used to predict the health status of the individual.

28. A system for facilitating health monitoring of individuals, the system comprising:
a computer system that comprises one or more physical processors programmed with computer program instructions which, when executed, cause the computer system to:
obtain a prediction model comprising a plurality of nodes associated with organs or tissues, wherein the nodes comprise a first node associated with a first organ or tissue and a second node associated with a second organ or tissue;
obtain health information associated with an individual;
predict a status of the first organ or tissue of the individual based on the health information and a parameter of the first node associated with the first organ or tissue; and
predict a status of the second organ or tissue based on the predicted status of the first organ or tissue and a parameter of the second node associated with the second organ or tissue.

29. The system of claim 28, wherein the first organ or tissue is a first organ, and the second organ or tissue is a second organ.

30. The system of claim 28, wherein the first organ or tissue is a first tissue, and the second organ or tissue is a second tissue.

31. The system of claim 28, wherein the first organ or tissue is a tissue, and the second organ or tissue is an organ, or wherein the first organ or tissue is the organ, and the second organ or tissue is the tissue.

32. The system of claim 28, wherein the health information comprises one or more of measurements of the individual or health conditions of the individual.

33. The system of claim 28, further comprising one or more remote health monitoring devices, each of which comprises one or more sensors programmed to collect health-related sensor data, and one or more physical processors programmed with computer program instructions which, when executed, cause the remote health monitoring device to obtain, based on the sensors, the health information associated with individual, and provide the health information to the computer system.

34. A method of facilitating health monitoring of individuals, the method being implemented by a computer system that comprises one or more physical processors executing computer program instructions which, when executed, perform the method, the method comprising:
obtaining, by the computer system, a prediction model comprising a plurality of nodes associated with organs or tissues, wherein the nodes comprise a first node associated with a first organ or tissue and a second node associated with a second organ or tissue;
obtaining, by the computer system, health information associated with an individual;
predicting, by the computer system, a status of the first organ or tissue of the individual based on the health information and a parameter of the first node associated with the first organ or tissue; and
predicting, by the computer system, a status of the second organ or tissue based on the predicted status of the first organ or tissue and a parameter of the second node associated with the second organ or tissue.

35. The method of claim 34, wherein the first organ or tissue is a first organ, and the second organ or tissue is a second organ.

36. The method of claim 34, wherein the first organ or tissue is a first tissue, and the second organ or tissue is a second tissue.

37. The method of claim 34, wherein the first organ or tissue is a tissue, and the second organ or tissue is an organ, or wherein the first organ or tissue is the organ, and the second organ or tissue is the tissue.

38. The method of claim 34, wherein the health information comprises one or more of measurements of the individual or health conditions of the individual.

39. A system for facilitating health monitoring of individuals, the system comprising:
a computer system that comprises one or more physical processors programmed with computer program instructions which, when executed, cause the computer system to:
obtain a prediction model comprising a plurality of nodes associated with organs or tissues, wherein the nodes comprise a first node associated with a first organ or tissue and a second node associated with a second organ or tissue;
obtain health information associated with an individual;
modify the first node associated with the first organ or tissue based on the health information;
modify the second node associated with the second organ or tissue based on the modified first node; and
provide a health status of the individual with respect to the second organ or tissue based on the modified prediction model.

40. The system of claim 39, wherein the first organ or tissue is a first organ, and the second organ or tissue is a second organ.

41. The system of claim 39, wherein the first organ or tissue is a first tissue, and the second organ or tissue is a second tissue.

42. The system of claim 39, wherein the first organ or tissue is a tissue, and the second organ or tissue is an organ, or wherein the first organ or tissue is the organ, and the second organ or tissue is the tissue.

43. The system of claim 39, wherein the health information comprises one or more of measurements of the individual or health conditions of the individual.

44. The system of claim 39, further comprising one or more remote health monitoring devices, each of which comprises one or more sensors programmed to collect health-related sensor data, and one or more physical processors programmed with computer program instructions which, when executed, cause the remote health monitoring device to obtain, based on the sensors, the health information associated with individual, and provide the health information to the computer system.

45. A method of facilitating health monitoring of individuals, the method being implemented by a computer system that comprises one or more physical processors executing computer program instructions which, when executed, perform the method, the method comprising:
obtaining, by the computer system, a prediction model comprising a plurality of nodes associated with organs or tissues, wherein the nodes comprise a first node associated with a first organ or tissue and a second node associated with a second organ or tissue;
obtaining, by the computer system, health information associated with an individual;
modifying, by the computer system, the first node associated with the first organ or tissue based on the health information;
modifying, by the computer system, the second node associated with the second organ or tissue based on the modified first node; and
providing, by the computer system, a health status of the individual with respect to the second organ or tissue based on the modified prediction model.

46. The method of claim 45, wherein the first organ or tissue is a first organ, and the second organ or tissue is a second organ.

47. The method of claim 45, wherein the first organ or tissue is a first tissue, and the second organ or tissue is a second tissue.

48. The method of claim 45, wherein the first organ or tissue is a tissue, and the second organ or tissue is an organ, or wherein the first organ or tissue is the organ, and the second organ or tissue is the tissue.

49. The method of claim 45, wherein the health information comprises one or more of measurements of the individual or health conditions of the individual.
